(19) United States
(12) Patent Application Publication
(10) Pub. No.: US 2018/0066654 A1
(43) Pub. Date: Mar. 8, 2018

(54) BROACHING AND/OR FRICTION WELDING TECHNIQUES TO FORM UNDERCUT PDM STATORS

(71) Applicant: Basintek, LLC, Houston, TX (US)

(72) Inventors: Peter Thomas Cariveau, Houston, TX (US); Chinh Trung Nguyen, Houston, TX (US)

(21) Appl. No.: 15/692,591

(22) Filed: Aug. 31, 2017

Related U.S. Application Data
(60) Provisional application No. 62/383,217, filed on Sep. 2, 2016.

(51) Int. Cl. F04C 2/107; B23F 15/08

(52) U.S. Cl. CPC F04C 2/1075; E21B 4/02; B23F 15/08

(57) ABSTRACT

In some embodiments, a method is disclosed for manufacturing an undercut stator from a unitary cylindrical workpiece using broaching techniques. In other embodiments, methods are disclosed for manufacturing undercut and non-undercut stators using friction welding techniques to conjoin threaded end sections to stator sections having helical pathways formed therein.

### RELATED APPLICATIONS

This application claims the benefit of, and priority to, commonly-invented and commonly-assigned U.S. Provisional Patent Application Ser. No. 62/383,217, filed Sep. 2, 2016. The disclosure of 62/383,217 is incorporated herein by reference in its entirety.

### FIELD OF THE DISCLOSURE

This disclosure is directed generally to manufacturing techniques for forming helical pathways in metal tubes to make so-called “even walled” stators used in subterranean positive displacement motors (“PDMs”), and more particularly to such techniques that use broaching to form an “undercut” stator. Disclosed embodiments further provide threaded end connections attached to stator tubes via high strength friction welded connections.

### BACKGROUND OF THE DISCLOSED TECHNOLOGY

It is well understood that so called “even walled” PDM stators comprise a layer of resilient elastomer or rubber deployed on helical pathways formed on the inner cylindrical surface of a metal tube. In order to enable rotation of a rotor inside the stator, the helical pathways are typically identical in geometry. The maximum cut depth of the “grooves” or “valleys” of the helical pathways is known as the major helical diameter of the pathway when viewed in the same plane as the nominal internal cylindrical diameter of the tube into which the pathways are formed. Similarly, the corresponding cut depth at the maximum height of the “lobes” or “hills” of the helical pathways is known as the minor helical diameter. The major helical diameter will always be greater than the nominal internal cylindrical diameter of the tube into which the pathways are formed. The minor helical diameter may be the same or greater than the nominal internal cylindrical diameter of the tube, depending on the manufacturing specification and technique.

It is also well understood that conventional PDM stators are connectable into a drill string via threaded joints at either end. At least one of the threaded joints is a box connection, and typically both are. The threaded end connections provide a minimum thread diameter through which the rotor must pass in order to be operably introduced into a service-ready stator. For purposes of this disclosure, an undercut stator is a stator whose major helical diameter is greater than the minimum thread diameter on the end connection of the stator.

Undercut stators are well known in the prior art. Undercut stators are disclosed, for example, in U.S. Pat. No. 6,427,787, U.S. Published Patent Application 2010/0284843, and German patent disclosure DE 19821065. Recently, Underwood et al. disclosed undercut stators in U.S. Published Patent Application 2011/0243774 (now U.S. Pat. No. 9,393,648) (hereafter referred to as “Underwood”). The relationship described above defining an undercut stator with reference to the minimum end thread diameter and the major helical diameter is illustrated on FIG. 2B of Underwood, in which item 135 is the minimum end thread diameter (called a pass-through diameter in Underwood), and item 140 is the major helical diameter (called the major tube diameter in Underwood). Item 139 on FIG. 2B is the undercut of the stator.

The advantages provided by undercut stators are well recognized. For example, an undercut stator retains the strength of the end connection but also allows for the largest possible power section geometry for maximum PDM power density.

However, manufacturing an undercut stator presents manufacturing challenges that have not been well addressed in the prior art. For example, Underwood discloses using Electrochemical Machining (ECM) processes to form helical pathways into a tubular workpiece. In Underwood, the undercut is then provided by mechanically working (colloquially, “squeezing”) the ends of the tube to a smaller outside diameter, so that a minimum thread diameter may be formed in the ends that is smaller than the major helical diameter. Underwood discloses the mechanical working step as accomplished via hot or cold forming, or via swaging.

Although Underwood discloses that his manufacturing method provides an advantageous product in that the finished stator is of unitary construction, Underwood's manufacturing method combines ECM and swaging, which as manufacturing steps are highly disadvantageous as compared to alternatives. Underwood discloses ECM using a multi-piece electrode to achieve oversized profile geometry in order to form helical pathways in the cylindrical stator tube. This is not a practical solution and provides a very tedious production process for assembly and operation. Conventional electrode designs that might accomplish this type of process have many performance and reliability issues that can lead to a highly variable process and poor yield of finished parts. Further, the difficulty of regulating current across multi-piece ECM head assemblies may cause uneven material removal during the ECM process itself.

Further, adding a swaging step to manufacturing, as disclosed in Underwood, is also highly disadvantageous. Swaging machines are expensive to buy and maintain, and have a large footprint on the shop floor. Swaging machines require their own set of dies to perform mechanical working. Swaging is a comparatively slow manufacturing process. The swaged sections typically require heat treatment after mechanical working in order to distribute the mechanical stresses built up in the swaged sections as a result of mechanical working. Maintaining swaging dies and heat treatment facilities adds yet further cost and manufacturing time to the overall manufacturing process. There is also additional risk in swaging that the tube will warp or crack during mechanical working or heat treatment.

Other prior art references (such as U.S. Pat. No. 6,427,787 to Jager) disclose an undercut stator that has a thin wall and spiral outer shape. The stator is manufactured using a hot rolling process. While the stator is of unitary construction, the manufacturing method causes a significant reduction of wall thickness during the hot rolling process, leading to an inevitably weak and comparatively fragile stator. Undercut stators manufactured this way are limited in their industrial application to drilling jobs in which only low to moderate drilling pressures and temperatures are expected.

Broaching is a much more advantageous manufacturing technique for forming helical pathways in the cylindrical stator. Broaching is a reliable, economical and precise manufacturing method for forming helical pathways on the inside of tubes. The broaching of internal helical pathways has been known in the gun barrel art for almost a century. See, for example, U.S. Published Patent Application 2007/0258783 and U.S. Pat. No. 2,896,514, and references cited therein. More recently, broaching has been disclosed as a manufacturing technique for conventional (i.e., not undercut) stators. See U.S. Published Patent Application 2012/028834.

It is further known to be advantageous in the subterranean PDM stator manufacturing art to be able to design different end connections (typically threaded end connections) for the specific downhole service seen by the end connections. For example, directional drilling is known to place heavy bending stresses on the threaded end connections downhole. In many applications, these bending stresses call for end connections to be ideally made from higher yield strength steel. However, higher yield strength steel may be less optimal for forming internal pathways in the stator tube interposed between the end connections, especially when using cutting techniques such as broaching to form the helical pathways. Ease of machining in the broaching process calls for steel with higher toughness. It is thus not always optimal for PDM stators to be of a unitary construction (such as disclosed in Underwood and other references), particularly when the application calls for different materials being optimal for different portions of the stator.

The threaded end connection is also one of the most replaced portions of a PDM stator throughout the stator's service life. Exposed threads on the end connections can wear out or become damaged during normal downhole service long before the threaded helical pathways on the stator tube are no longer serviceable from wear or damage. It is thus optimal to be able to replace end connections on stator tubes whose internal helical pathways are otherwise still serviceable.

Attachment of end connections to stator tubes is also an area where improvement can be made in the art. It is conventional to arc weld smaller diameter threaded end connections to tubes providing pre-formed helical pathways in order to obtain undercut stator geometry. See, for example, U.S. Published Patent Application 2010/0284843, also to Jager. Use of traditional arc welding as disclosed in Jager is a disadvantageous process. Traditional arc welding creates thermal stresses in and around the welded joints, and as a result, the welded connections tend to display poor fatigue resistance. Although all welding is likely to create thermal stresses, friction welding in known generally as a process that creates serviceable welded joints with comparatively fewer thermal stress issues. Successful friction welding is also recognized to provide high strength joints with excellent fatigue resistance.

In more detail, friction welding is known as a solid-state welding process that generates heat through mechanical friction between workpieces in relative motion to one another. Once the friction has caused softening of the contact portions of the workpieces, a lateral force is applied to plastically displace and fuse the materials.

One type of friction welding is inertia welding. Inertial welding is one of the techniques currently preferred in methods described below in this disclosure. In inertia welding, one workpiece rotates and the other is fixed. The rotating workpiece is attached to a motor and a flywheel, and then rotated at high speed in order to store kinetic energy in the flywheel. Once the workpiece and flywheel assembly is spinning at the proper speed, the motor is disengaged, allowing the flywheel to generate continued rotation. The workpieces (rotating and fixed) are forced together laterally under pressure. The kinetic energy stored in the rotating flywheel is dissipated as heat at the weld interface as the flywheel speed decreases.

Another currently preferred friction welding technique is direct drive friction welding. There is no fly wheel in direct drive friction welding. Instead, the rotating workpiece is driven by the motor while the lateral force engages the contact surfaces of the workpieces.

The friction welding techniques described immediately above may further be assisted by heating the workpieces before or during welding with extrinsic heat sources. Induction heaters in coil or annular form may be placed around the rotating workpiece(s) to further heat the workpiece contact areas to the desired softening temperature. Alternatively, infrared heaters may be used to achieve the same effect.

There is therefore a need in the art for broaching methods that could be adapted to manufacture stators with undercut helical geometries as disclosed in Underwood. Such broaching methods would overcome the many manufacturing and stator performance drawbacks presented by alternative manufacturing methods currently disclosed in the art, such as ECM/swaging, hot/cold forming or traditional arc welding. There is a need for broached undercut stators where the broaching forms the undercut helical internal pathways and upset end connections all as one integral workpiece. There is also a need for stators (both undercut and non-undercut) having end connections designed for end connection service in their own right. Such end connections could then be attached to a tube with broached internal helical pathways, where the end connection and tube together provide an undercut geometry. Alternatively, such end connections could be attached to a tube with internal helical pathways made by techniques other than broaching and/or where the end connection and tube together provide a non-undercut geometry. Regardless of the embodiment, the attachment between end connection and tube would be via a high strength connection, where the connection also generates few thermal stresses.

### SUMMARY OF DISCLOSED TECHNOLOGY AND TECHNICAL ADVANTAGES

These and other drawbacks in the prior art are addressed by using broaching methods to form helical pathways into a tubular workpiece to make an undercut stator. Currently preferred embodiments deploy an extensible broaching cutting tool head to form the helical profile geometry of an “even walled” stator to where the major helical diameter is greater than the minimum thread diameter of the stator's threaded end connections (per Underwood FIG. 2B, as described in the “Background” section above). The final broached undercut stator product according to these embodiments is of unitary construction. This disclosure is not limited to these embodiments, however. Other exemplary embodiments are described where the end pieces are designed for specific advantageous service in their own right, and then attached to a tube with internal helical pathways via high strength friction welded connections. Such welded connection embodiments are not limited to broached stators, or stators with undercut geometries. In all cases, the resulting product is a highly advantageous undercut stator.

In embodiments disclosed herein directed to broached stators with end connections formed from one workpiece, it is therefore a technical advantage of such broaching methods not to need any additional manufacturing steps to reduce the end diameters of a tubular workpiece into which helical pathways have previously been formed. The disadvantages of reducing the end diameters of an ECM-formed undercut stator via a mechanical working process such as swaging, as disclosed in Underwood, were discussed above in the “Background” section. The disclosed broaching methods require no additional heating or reforming operations and the finished broached stator is ready to have its ends threaded once broaching is complete.

In embodiments disclosed herein directed to stators with high strength welded end connections joined to intervening tubes in which helical pathways have been formed, it is therefore a technical advantage of such welded stator constructions to enable end connections to be selected from different materials than the intervening tubes. As described in more detail elsewhere in this disclosure, in some stator applications, material selection for end connections may be according to different criteria than for the intervening tubes in which helical pathways are formed. Generally, although not in every case, the end connections will advantageously be made from a higher yield strength steel than the tubes, the end connections (and the threads formed therein) being subject to high bending stresses during service in deviated wells. By contrast, the tubes will advantageously be made from a lower yield strength steel in order to facilitate formation of helical pathways in the tubes.

High strength welds in stator deployments are advantageous in their own right in the disclosed stator applications. It will be recognized that especially in undercut stator geometries, a portion of the stator wall between the helical pathways and the end connection may be comparatively thin. Refer to FIG. 2B of Underwood, for example, described in the Background section above. This thin profile may create an inherent weakness, especially considering the helical pathway material and the end connection material either side are thicker and therefore stiffer. Forming a high strength weld between end connection and helical pathways addresses, at least in part, the inherent weakness of an otherwise thin portion of the stator wall.

Further, in embodiments directed to stators with high strength welded end connections, it is a technical advantage of such stators for the high strength welds to be formed by friction welding. A friction weld eliminates the cast metal microstructure seen in a welded joint formed by other welding processes, such as (without limitation) arc welding, submerged arc welding, laser welding, tungsten inert gas (TIG) welding, manganese inert gas (MIG) welding, or electron beam welding. The cast microstructure seen in joints produced by these other welding processes is known to produce a coarse and defect-rich material composition that can have a poor fatigue life. By contrast, the friction weld process produces a welded joint with a wrought grain microstructure of fine grains similar to that seen in a highly-worked forged material. This wrought grain microstructure is associated with excellent fatigue characteristics and high strength.

It will be understood that the scope of this disclosure is not limited to any particular type of friction welding technique. Among currently available friction welding techniques, however, currently preferred embodiments favor “spinning” techniques over friction “stir” techniques for forming high strength welded joints for joining end connections to the intervening tube. Methods that use rotary tools to “stir” two pieces together in a friction bonded assembly may not prove optimal in many stator applications. The need for a rotary friction stirring head and tool in the stirring technique may create additional manufacturing complexity. Also, a stirring technique may impose residual stresses in the workpiece. There are also practical difficulties aligning the workpieces in stirring techniques used in stator applications. By contrast, the spinning technique is more likely to be cost effective in stator applications, producing a high quality weld with high uniformity and with no need of additional tooling or joining materials.

In a first aspect, therefore, this disclosure describes a method for manufacturing one end of an undercut stator, the method comprising the steps of: (a) providing a cylindrical tube as a single workpiece, the tube having a tube length and a cylindrical internal surface; (b) designating a first end connection portion of the tube length at a first end of the tube, and designating a stator portion of the tube length wherein the stator portion immediately neighbors the first end connection portion; (c) forming a plurality of helical pathways on the internal surface of the stator portion, each helical pathway having a common major helical diameter and a common minor helical diameter, wherein step (c) includes the substep of (c1) forming at least one of the helical pathways at least in part by broaching; and (d) forming threads on the internal surface of the first end connection portion such that the threads provide an internal minimum thread diameter, wherein the major helical diameter is selected to be greater than the internal minimum thread diameter. The method may further comprise, after step (c), the step of deploying a layer of elastomer on the helical pathways. In some embodiments, substep (c1) may further include forming at least one of the helical pathways (1) initially by electrochemical machining (ECM), and then (2) by broaching to finish. In some embodiments, the broaching in substep (c1) may be controlled at least in part by computerized numeric control (CNC).

In a second aspect, this disclosure describes method for manufacturing one end of an undercut stator, the method comprising the steps of: (a) providing an end tube with a cylindrical end internal surface and an end tube nominal diameter; (b) providing a stator tube with a cylindrical stator internal surface; (c) forming a plurality of helical pathways on the stator internal surface, each helical pathway having a common major helical diameter and a common minor helical diameter; (d) designating a connecting end of the end tube and a connecting end of the stator tube, wherein the connecting ends of the end tube and the stator tube are to be conjoined; (e) preparing the connecting ends of the end tube and the stator tube for friction welding together; (f) friction welding the connecting ends of the end tube and the stator tube together; and (g) forming threads on the end internal surface such that the threads provide an internal minimum thread diameter, wherein the major helical diameter is selected to be greater than the internal minimum thread diameter. In some embodiments, the method may further comprise, after step (c), the step of deploying a layer of elastomer on the helical pathways. In some embodiments, step (e) includes machining cooperating flat faces onto the connecting ends of the end tube and the stator tube. In some embodiments, step (f) is accomplished at least in part by a process selected from the group consisting of (1) inertia welding, and (2) direct drive welding. In some embodiments, step (c) is accomplished at least in part by a process selected from the group consisting of (1) electrochemical machining (ECM), (2) roll forming and (3) broaching. In some embodiments, step (f) also includes machining a stress-relieving geometry into a transition between the stator internal surface and the end internal surface, the transition formed when the end tube is friction welded to the stator tube. In some embodiments, the end tube is made from a material having a higher yield strength than the material from which the stator tube is made. In some embodiments, a welded connection is formed between the connecting ends of the end tube and the stator tube when the end tube is friction welded to the stator tube in step (f). In such embodiments, the welded connection may be located at a position selected from the group consisting of (1) minimum transverse cross-sectional area along the helical pathways formed in the stator tube, (2) maximum transverse cross-sectional area along the helical pathways formed in the stator tube, and (3) maximum transverse cross-sectional area of the end tube. In such embodiments, the welded connection may be located at a position along the helical pathways formed in the stator tube; and portions of the welded connection may be removed after step (f) in order to provide a smooth transition between helical pathways and the end internal surface. In such embodiments, step (c) may be accomplished at least in part by broaching, wherein said broaching includes forming a relief bore in the stator, and in which the welded connection is located in the relief bore. In such relief bore embodiments, step (e) may include forming a transition in the end internal surface at the connecting end of the end tube, wherein the transition enlarges the end tube nominal internal diameter to a diameter substantially equal to the relief bore diameter.

In a third aspect, this disclosure describes a method for manufacturing one end of a stator, the method comprising the steps of: (a) providing an end tube with a cylindrical end internal surface; (b) providing a stator tube with a cylindrical stator internal surface; (c) forming a plurality of helical pathways on the stator internal surface, each helical pathway having a common major helical diameter and a common minor helical diameter; (d) designating a connecting end of the end tube and a connecting end of the stator tube, wherein the connecting ends of the end tube and the stator tube are to be conjoined; (e) preparing the connecting ends of the end tube and the stator tube for friction welding together, and (f) friction welding the connecting ends of the end tube and the stator tube together. In some embodiments, the method further comprises, after step (c), the step of deploying a layer of elastomer on the helical pathways. In some embodiments, the end tube is made from a material having a higher yield strength than the material from which the stator tube is made. In some embodiments, a welded connection is formed between the connecting ends of the end tube and the stator tube when the end tube is friction welded to the stator tube in step (f). In such embodiments, the welded connection may be located at a position selected from the group consisting of (1) minimum transverse cross-sectional area along the helical pathways formed in the stator tube, (2) maximum transverse cross-sectional area along the helical pathways formed in the stator tube, and (3) maximum transverse cross-sectional area of the end tube. In such embodiments, the welded connection may be located at a position along the helical pathways formed in the stator tube; and portions of the welded connection may be removed after step (f) in order to provide a smooth transition between helical pathways and the end internal surface.

The foregoing has rather broadly outlined some features and technical advantages of the disclosed manufacturing techniques, in order that the following detailed description may be better understood. Additional features and advantages of the disclosed technology may be described. It should be appreciated by those skilled in the art that the conception and the specific embodiments disclosed may be readily utilized as a basis for modifying or designing other structures for carrying out the same inventive purposes of the disclosed technology, and that these equivalent constructions do not depart from the spirit and scope of the technology as described.

### BRIEF DESCRIPTION OF THE DRAWINGS

For a more complete understanding of the embodiments described in this disclosure, and their advantages, reference is made to the following detailed description taken in conjunction with the accompanying drawings, in which:

FIGS. 1A, 1B and 1C are flow charts describing exemplary stator manufacturing techniques consistent with this disclosure, in which FIG. 1A depicts manufacturing an integral (i.e., single-piece) stator tube/end connection assembly with broached undercut internal helical pathways, FIG. 1B depicts manufacturing a stator tube with internal helical pathways to which end connections are friction welded, and FIG. 1C depicts replacing damaged end connections on a stator tube via friction welding new end connections thereon;

FIGS. 2A and 2B illustrate stages in the exemplary manufacturing technique also described with reference to FIG. 1A;

FIGS. 3 through 7 illustrate different embodiments of stators with friction welded end connections consistent with manufacturing embodiments exemplified by FIGS. 1B and 1C, wherein each of FIGS. 3 through 7 depict locating the friction weld at varying locations with respect to helical pathways formed on the stator tube; and

FIG. 8 is an enlargement of details on FIG. 7, as shown on FIG. 7.

### DETAILED DESCRIPTION

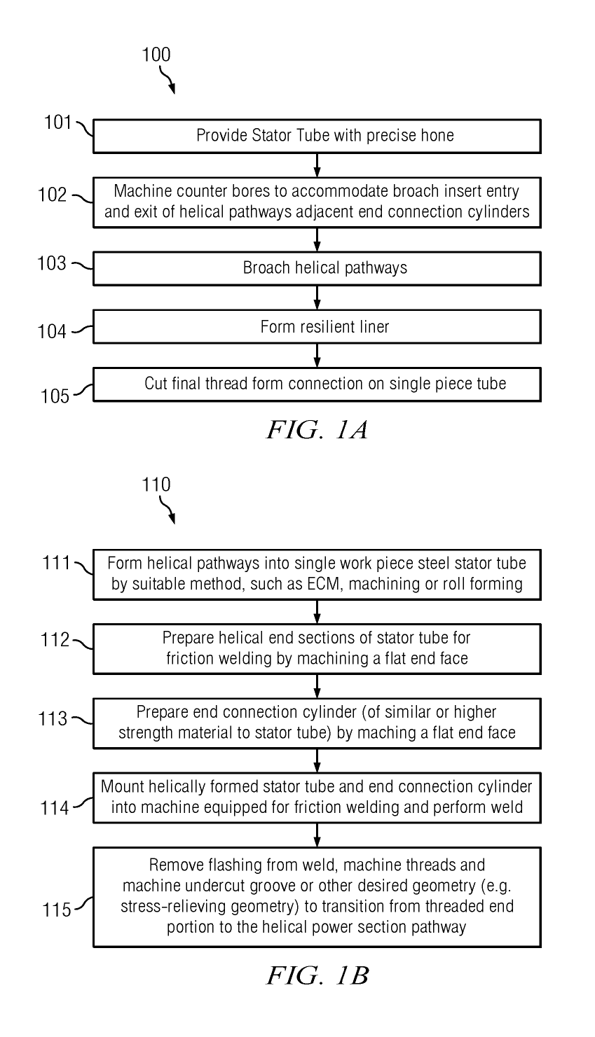

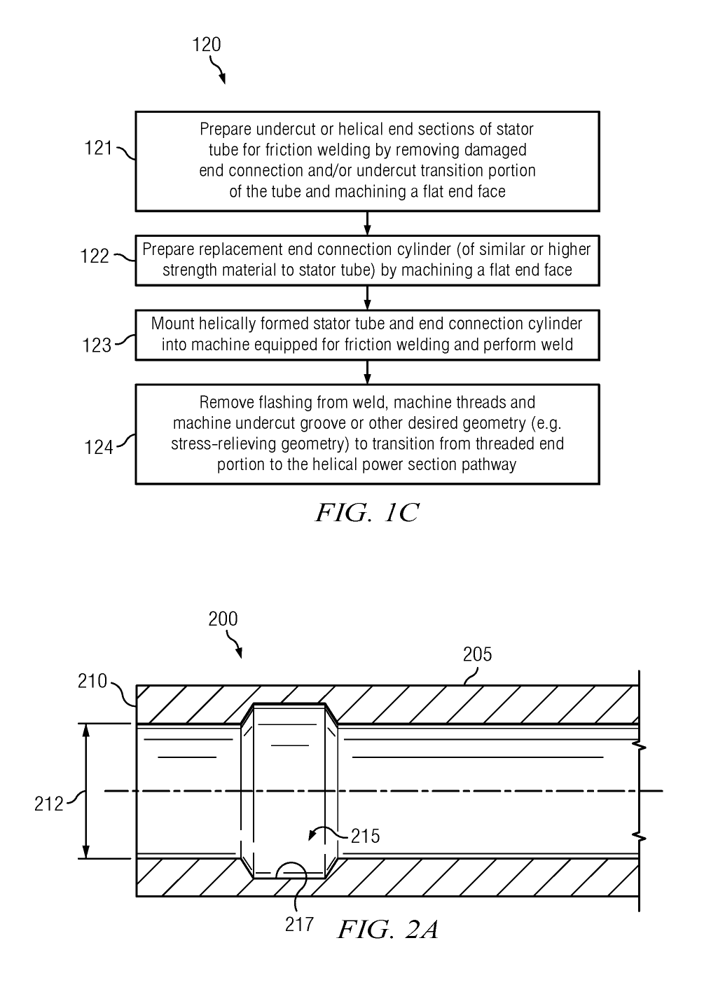

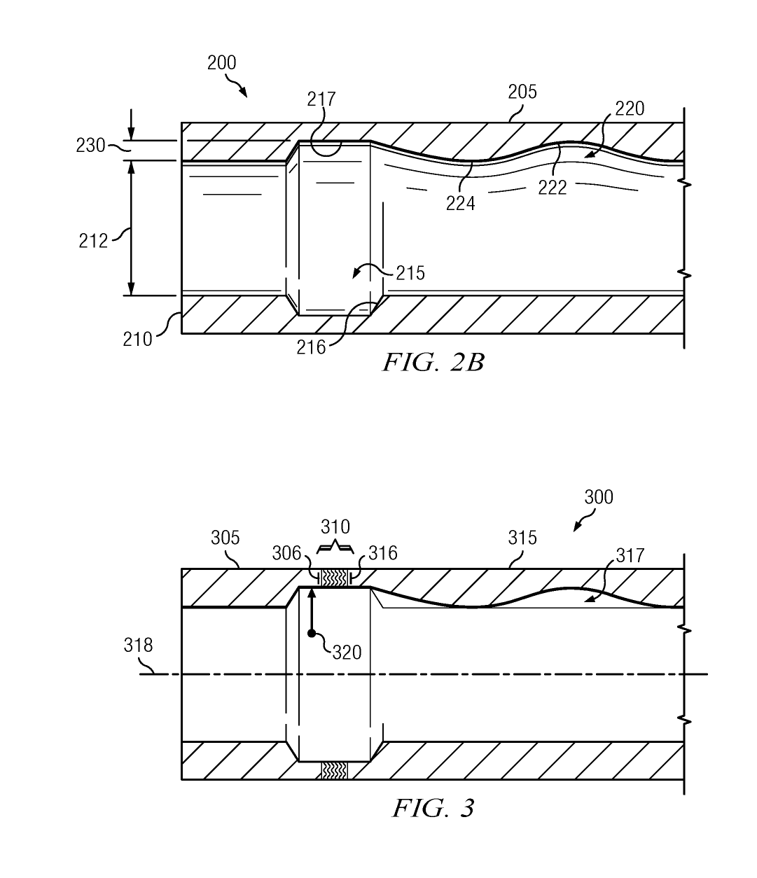

FIGS. 1A, 1B and 1C are flow charts depicting, in summary diagrammatic form, currently preferred embodiments of exemplary manufacturing techniques consistent with this disclosure. FIG. 1A should be viewed in conjunction with FIGS. 2A and 2B and associated text below. FIG. 1A describes an embodiment where an undercut stator is manufactured using broaching techniques in a unitary construction, i.e. where the helical pathways and end connections are formed integrally by broaching a single or unitary tubular workpiece. FIGS. 2A and 2B illustrate the same broached stator 200 of unitary construction that is being manufactured by embodiments exemplified by FIG. 1A, but at different stages of manufacture. FIG. 2A illustrates broached stator 200 after box 102 on FIG. 1A. FIG. 2B illustrates broached stator 200 after (or during) box 103 on FIG. 1A. Features and aspects of broached stator 200 that are illustrated on both FIGS. 2A and 2B have the same part number.

FIGS. 1B and 1C should be viewed in conjunction with FIGS. 3 through 8 and associated text below. FIG. 1B describes embodiments where a stator (undercut or non-undercut) is manufactured preferably using broaching techniques to form helical pathways inside a tube, and where the end connections are welded onto the ends of the stator tube using high strength welding techniques. FIG. 1C describes embodiments where an existing stator (undercut or non-undercut) with a damaged end connection may be repaired by removing the damaged end connection and welding a new end connection onto the stator using high strength welding techniques.

FIGS. 3 through 8 depict different embodiments of welded end connections formed by the methods illustrated in FIG. 1B or 1C. The welded end connections illustrated in FIGS. 2 through 8 are indifferent to whether formed according to FIG. 1A or FIG. 1B. A primary difference among FIGS. 3 through 7 is the location of the welded end connection with respect to other features of the stator. FIG. 8 is an enlargement of details of FIG. 7, as shown on FIG. 7.

It should be emphasized that embodiments exemplified by FIG. 1A (in conjunction with FIGS. 2A and 2B and associated text below) are confined to undercut stators of unitary one-piece construction made primarily by broaching techniques. By contrast, embodiments exemplified by FIGS. 1B and 1C (in conjunction with FIGS. 3 through 8 and associated text below) include stators with high strength welded end connections that are indifferent to whether the final stator product is undercut or non-undercut. Likewise, FIGS. 1B and 1C (in conjunction with FIGS. 3 through 8 and associated text below) include stators with high strength welded end connections that are indifferent to whether the final stator product's internal helical pathways are formed by broaching, or by some other manufacturing technique. Currently preferred embodiments exemplified by FIGS. 1B and 1C are undercut stators whose helical pathways are formed by broaching, in view of (1) the improved power density provided by undercut stators, and (2) the improved machinability provided by broaching, plus other advantages described elsewhere in this disclosure. However, it will be appreciated that embodiments exemplified by FIGS. 1B and 1C are not limited to undercut stators, and are not limited to stators whose internal helical pathways are formed by broaching. Both undercut and non-undercut stators, regardless of how their helical pathways are/were formed, will benefit from the disclosed advantages of selecting end connections made of material designed for specific end connection service, and then attaching same to a stator tube made of a different material via a high strength welded connection.

Referring first to FIG. 1A, method 100 begins, in preferred embodiments, with providing a blank stator tube with a precise hone (box 101). The “precise hone” aspect of the stator tube refers to a preference for a high-quality smooth internal surface of known internal diameter on the native tubular workpiece immediately prior to counter bore and broaching operations.

The tubular workpiece begins with a conventional wall thickness suitable for threading to form a desired end connection after broaching. The first phase of the method is to form a counter bore inside the workpiece (box 102 on FIG. 1A). The counter bore is formed at a large enough longitudinal distance inside the tube to allow the portion of the tube nearest the end to be long enough to be formed into the desired end connection. The counter bore may be formed in the tubular workpiece by machining, broaching or other suitable conventional techniques. The expandable/extensible broaching head and cutting tool assembly may then be inserted into the relief counter bore with sufficient room available to begin its broaching work. Refer also to FIG. 2A, in which broached stator 200 comprises counter bore 215 separating end connection portion 210 and helical pathway portion 205. Counter bore 215 has created relief bore diameter 217 that is larger than original tube bore diameter 212.

Refer now to box 103 on FIG. 1A. A specialized expandable/extensible broaching head and cutting tool assembly is then introduced into the counter bore. The counter bore allows the broaching tool head assembly sufficient space to be expanded to form the helical pathways with a major helical diameter that is greater than the minimum threaded end diameter. Helical pathway cutting is advantageously controlled by computerized numerical control (CNC).

Refer also to FIG. 2B, depicting broached stator 200 after (or during) the broaching of helical pathways 220 into helical pathway portion 205. Helical pathways are formed with a major helical diameter 222 and a minor helical pathway 224. FIG. 2B illustrates undercut 230 formed by the difference between major helical diameter 222 and original tube bore diameter 212. It will be appreciated that a minimum thread diameter will be identified when eventually the desired thread form is cut into tube bore diameter 212 in end connection portion 210 (thread form not illustrated on FIGS. 2A and 2B, but referred to in box 105 on FIG. 1A). The desired thread form may be constant diameter or varying diameter, per user selection. However a minimum thread diameter will result, regardless of the shape of the thread form. At that point, undercut 230 on FIG. 2B will be the difference between major helical diameter 222 and the minimum thread diameter formed in tube bore diameter 212 in end connection portion 210.

Referring to box 103 on FIG. 1A in more detail, the height of the cutting tool assembly itself during broaching is controlled on a wedge support system built into the broaching tool head assembly. A wedge is pushed in or out to bring the cutter to a new cutting diameter upon each successive stroke. Consistent with conventional broaching techniques, the helical pathways are formed by making successive incremental cuts into the inside diameter of the tubular workpiece according to a programmed cut profile. The broaching head (and associated cutting tool) maintains its radial position by being stabilized on ribbons of workpiece material left uncut on the internal diameter of the workpiece. In currently preferred embodiments, a fixed cylindrical stabilizing pad, or centering chuck, on which the broaching cutter head assembly is mounted, is kept in sliding contact with the helical ribbons on the workpiece's internal diameter throughout the cutting process. In the final steps of shaping the helical profile, the helical ribbons may be rounded off by manufacturing techniques such as, for example, single point broaching, form tool broaching, shot blasting or shot peening.

Referring now to FIG. 2B, in some embodiments the relief bore diameter 217 on FIG. 2B may be the same as the intended final maximum helical diameter 222, and in other embodiments it may be slightly larger. Advantageously, counter bore 215 also provides a chamfer 216 into the work area of the broaching cutter, allowing the broaching cutter to load gradually upon entry into the workpiece material. In some embodiments, chamfer 216 may be 45 degrees.

Referring again to FIG. 1A, once broaching operations are complete, the stator product is completed by deploying the resilient elastomer liner on the broached helical pathways according to conventional techniques (box 104). The user-desired thread form is then cut into the end connection (box 105). Refer to the disclosure immediately above describing undercut 230 on FIG. 2B.

Further alternative embodiments of the disclosed broaching methods described above may use also techniques such as ECM to partially form the helical pathways in the tubular workpiece. The helical pathways may then be fully formed and finished using the broaching techniques described above.

FIGS. 1B and 1C depict alternative embodiments from the undercut stator manufacturing method described above with reference to FIG. 1A. In FIG. 1B, a stator (undercut or non-undercut) is manufactured by joining end connections to a stator tube in which helical pathways have previously been formed. The end connections are joined to the tube via high strength weld connections (advantageously, friction weld connections). The end connections may be made from a different material from the tube. FIG. 1C depicts a similar method to FIG. 1B, except that in FIG. 1C, a previously-used stator with damaged end connection(s) is repaired to provide new end connection(s) of selected material. As in FIG. 1B, the end connections in FIG. 1C are joined to the tube via high strength weld connections (and again, advantageously, friction weld connections).

Referring now to FIG. 1B, method 110 begins with forming helical pathways into a single (unitary) tubular workpiece by a suitable method (box 111). The scope of this disclosure is not limited to the methods by which helical pathways are formed on embodiments manufactured according to FIG. 1B. For example, ECM or roll-forming methods may be used to form the helical pathways. Alternatively, machining methods such as broaching may be used. Then, in box 112, the ends of the stator tube are prepared for friction welding onto end connections by machining a flat face onto the stator tube ends in a transverse plane that is normal to the longitudinal axis of the stator tube. In box 113, for each end of the stator tube, an end connection cylinder is prepared for friction welding on to the stator tube by machining a corresponding flat face onto the end connection cylinder in a normal transverse plane.

Box 114 on FIG. 1B depicts performing a high strength weld (advantageously, friction weld) between stator tube and end connection cylinder at the machined flat-faced ends. In currently preferred embodiments, friction welding is accomplished using inertia welding techniques, as described above in the “Background” section. Inertia welding is advantageous in stator applications in that one workpiece to be welded is rotated while the other is fixed. It will be appreciated that the end connection cylinder, as described on box 113 of FIG. 1B, may be more conveniently rotated because it is a short component as compared to the stator tube. Meanwhile, the stator tube, a comparatively long component, may be more conveniently fixed during inertia welding.

With further reference to box 114, it will be understood that various parameters may be programmed into the friction welding machine in order to achieve the desired weld. For inertial welding, the rotational speed of the workpiece and fly wheel will be optimized to provide the correct preheating and forging temperatures of the workpieces. Optimal rotational speeds will be in ranges determined by the flywheel size and the rotating workpiece size, as well as the amount of preheating that is applied to the workpiece from an extrinsic heat source (such as induction heaters or infrared heaters, refer discussion in Background section above). A further parameter governing the friction welding process is the thrust load urging the contact surfaces of the workpieces together. A light thrust load will be applied during the spinning and preheating stage of the welding process. After the workpieces are brought to the forging temperature, a higher thrust load is applied to the workpieces to create the wrought worked microstructure and to ultimately complete the weld. The magnitude and rate of increase of the thrust load will be optimized for the workpieces comprising the welded joint. The cooling rate of the weld and any subsequent post weld stress relief (via subsequent general heating of the finished welded joint) will also be optimized for the materials and geometry being joined.

Direct drive welding may be optimized in a similar manner to the inertial welding optimization described immediately above. With full friction welding machine programmability and control of rotational speed and thrust load, a wide variety of rotational speed and thrust load combinations can be anticipated to optimize the welded structure for strength and consistency.

Referring now to box 115 on FIG. 1B, now that the end connection cylinders have been joined to the stator tube, the end connection cylinders may be finished to desired specifications. The weld connection itself may be cleaned up, including the removal of flashing. Threads may be cut onto the interior of the end connection cylinder according to desired thread specifications. The interior transition from the end connection, over the weld, and into the stator tube helical pathways may also be machined according to desired transition specifications. For example, an upset configuration on the transition may be machined (e.g. via broaching) so as to create an undercut stator. Alternatively, or additionally, stress-relieving geometry may be machined into the transition to create a desired internal profile. This disclosure is not limited in this regard.

FIGS. 3 through 8 illustrate various exemplary embodiments of stator configurations that may be manufactured according to FIG. 1B (and FIG. 1C, as will be described further on in this disclosure). For the avoidance of doubt, FIG. 1B is not limited to the exemplary embodiments illustrated on FIGS. 3 through 8.

Referring first to FIG. 3, stator 300 comprises stator tube 315 joined to end connection 305 via friction weld 310. Stator tube 315 has helical pathways 317 formed therein via known techniques, such as ECM, machining, broaching or hot/cold rolling, or combinations thereof (refer box 111 on FIG. 1B and associated disclosure above). Stator tube end face 316 is machined onto stator tube 315, preferably in a transverse plane that is normal to longitudinal axis 318 (refer box 112 on FIG. 1B and associated disclosure above). End connection end face 306 is machined onto end connection 305, preferably also in a transverse plane that is normal to longitudinal axis 318 (refer box 113 on FIG. 1B and associated disclosure above). Friction weld 310 is performed joining end faces 306 and 316, and post-weld clean up, machining and thread cutting may be performed (refer boxes 114 and 115 on FIG. 1B and associated disclosure above).

In the embodiment illustrated on FIG. 3, arrow 320 denotes that stator 300 is designed such that friction weld 310 is placed at the point of minimum cross section. This allows for convenient initial formation of the helical pathways 317 (without any requirement, for example, for a pre-form such as a relief counter bore). The placement of friction weld 310 at the point of minimum cross section also facilitates subsequent repair or replacement of end connection 305 should it become damaged in service.

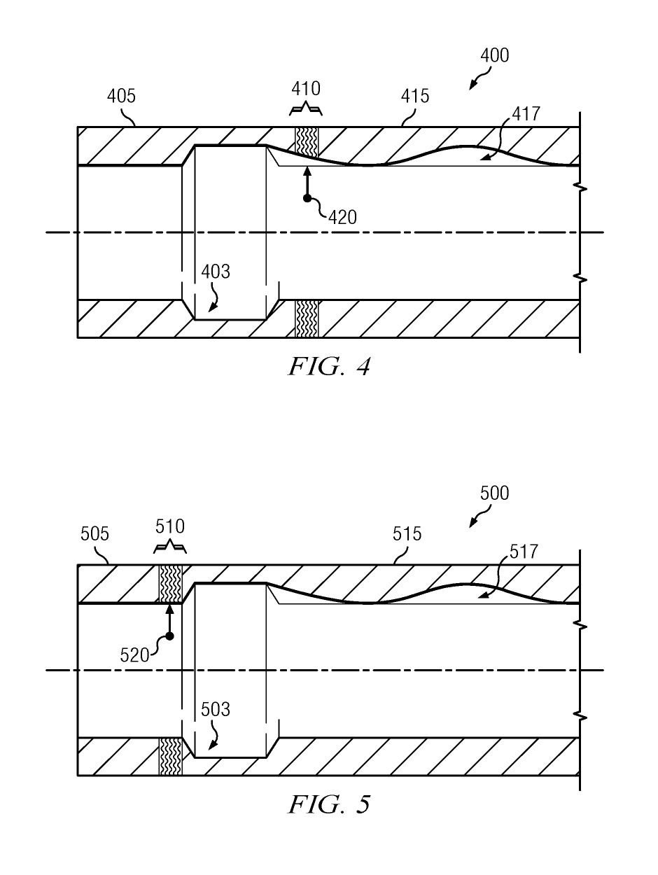

FIG. 4 illustrates an embodiment similar to FIG. 3, only in FIG. 4, stator 400 comprises stator tube 415 joined to end connection 405 via friction weld 410. Arrow 420 denotes that stator 400 is designed such that friction weld 410 is placed at the maximum cross section of helical pathways 417. In some embodiments, friction weld 410 may be placed from 1″ to 6″ further into stator 400 from undercut bore 403. Comparable to the embodiment illustrated in FIG. 3, the placement of friction weld 410 on FIG. 4 again allows for convenient initial formation of the helical pathways 417 (without any requirement, for example, for a pre-form such as a relief counter bore). At the same time, FIG. 4's placement of friction weld 410 allows for maximum strength in undercut 403's cross section in this type of welded-connection stator design, since undercut 403 on FIG. 4 is formed in end connection 405, which will typically be made from higher yield strength material.

FIG. 5 illustrates an embodiment similar to FIGS. 3 and 4, only in FIG. 5, stator 500 comprises stator tube 515 joined to end connection 505 via friction weld 510. Arrow 520 denotes that stator 500 is designed such that friction weld 510 is placed at the maximum cross section of end connection 505, so that undercut 503 is formed entirely in stator tube 515. The embodiment of FIG. 5 recognizes that typically (although not in every case), end connection 505 will be made from higher yield strength (and costlier) material than stator tube 515. Since undercut 503 is formed entirely in stator tube 515 on FIG. 5, formation of undercut 503 may be easier in lower yield strength material used in stator tube 515. At the same time, the amount of higher yield strength (and thus costlier) material used in end connection 505 is minimised in FIG. 5. It will be appreciated that the embodiment of FIG. 5 is ideal for the method described further below with reference FIG. 1C, in which a used stator's end connections may be replaced using high strength friction weld connections to new end connections.

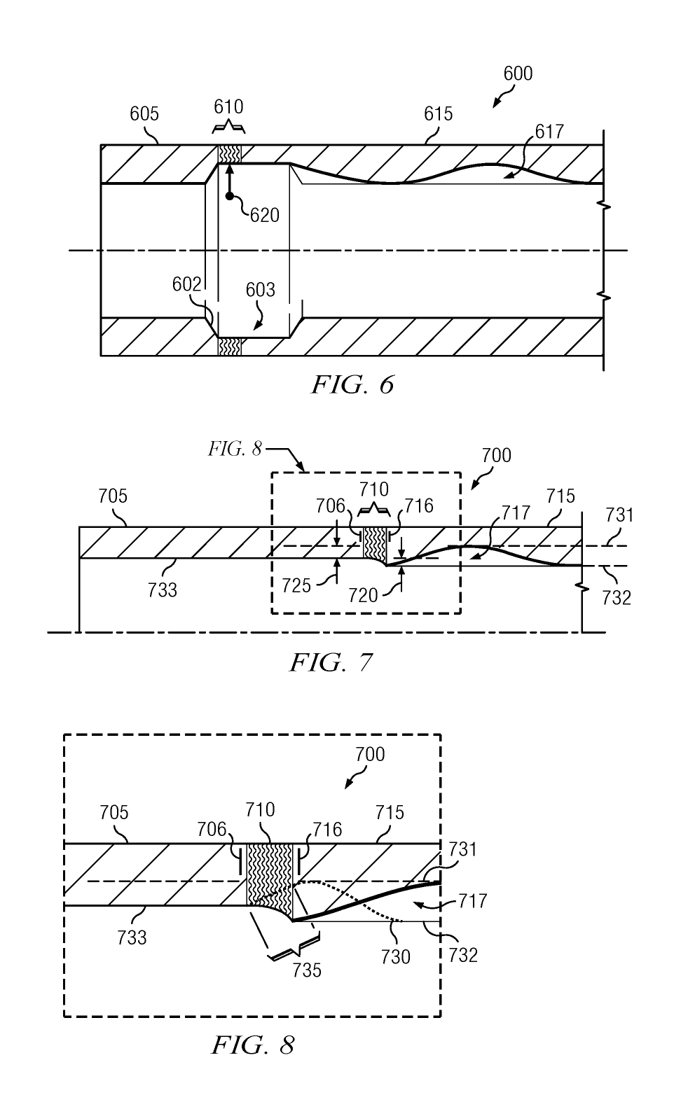

FIG. 6 illustrates an embodiment similar to FIG. 3, only in FIG. 6, stator 600 comprises stator tube 615 joined to end connection 605 via friction weld 610. In particular, the embodiment of FIG. 6 is similar to the embodiment of FIG. 3, inasmuch that arrow 620 denotes that stator 600 is designed such that friction weld 610 is placed such that friction weld 610 is placed at the point of minimum cross section of undercut 603. As with the embodiment of FIG. 3, this placement allows for convenient initial formation of the helical pathways 617 in stator tube 615 (without any requirement, for example, for a pre-form such as a relief counter bore). Further, as with the embodiment of FIG. 3, the placement of friction weld 610 at the point of minimum cross section facilitates subsequent repair or replacement of end connection 605 should it become damaged in service. Different from the embodiment of FIG. 3, however, the embodiment of FIG. 6 places friction weld 610 immediately next to transition 602 in end connection 605. This placement on FIG. 6 facilitates straightforward machining of both end connection 605 and stator tube 615 to achieve undercut 603 when end connection 605 and stator tube 615 are conjoined. Cleanup of weld 610 is also facilitated in the embodiment of FIG. 6.

FIGS. 7 and 8 should be viewed together. FIG. 8 is an enlargement of details of FIG. 7, as shown on FIG. 7. FIGS. 7 and 8 illustrate an embodiment in which stator 700 comprises stator tube 715 joined to end connection 705 via friction weld 710. Features and aspects of stator 700 that are illustrated on both FIGS. 7 and 8 have the same part number.

Referring first to FIG. 7, end connection 705 is a cylindrical or tubular shape with minimum thread diameter 733. Stator tube 715 has helical pathways 717 formed therein, and helical pathways have major helical diameter 731 and minor helical diameter 732. It will be appreciated from viewing FIG. 7 that in the illustrated embodiment, end connection 705 requires no machining or other work to provide an upset or transitional profile such as illustrated on comparative end connections on FIG. 3, 4 or 6. Likewise, in the embodiment illustrated on FIG. 7, stator tube 715 requires no counter bore or relief bore diameter in order to create an undercut geometry, such as illustrated on the comparative stator tube 515 on FIG. 5. Instead, the outside diameter and wall thickness of end connection 705 on FIG. 7 is selected such that minimum thread diameter 733 is less than major helical diameter 731, thus providing an undercut 725 on FIG. 7.

The embodiment of FIG. 7 thus provides an undercut stator design calling for minimum machining or other work of end connection 705. End connection 705 may begin as a cylinder, have end connection end face 706 formed thereon prior to friction welding Threads may be cut on the inside of end connection 705 after friction welding and helical pathway transition (as further described below). Likewise, the embodiment of FIG. 7 provides a design calling for minimum machining or other work of stator tube 715. Helical pathways 717 may be formed in stator tube 715, onto which stator tube end face 716 may be formed directly prior to friction welding.

Friction weld 710 on FIG. 7 is made so that on the stator tube 715 side, the welded joint is formed all the way across the lobes of helical pathways 715 to include minor diameter 732. This aspect for friction weld 710 to include minor helical diameter 732 is emphasized and enlarged on FIG. 8. With further reference to FIG. 8, dotted line 730 illustrates the horizon of the fluted helical pathway hidden behind. Distance 720 on FIG. 7 and distance 735 on FIG. 8 indicate the material that must be removed from friction weld 710 all around the circumference of stator 700 in order to provide a smooth transitional curvature from end connection 705 into helical pathways 717 after welding. This transition work may be performed at the same time that friction weld 710 is cleaned up to remove weld flash and other surplus after welding. In currently preferred embodiments, a further small undercut or relief may then be formed on the transitions to secure the termination edge of the elastomer lining deployed later on the helical pathways 717 (small undercut/relief not illustrated). Such weld clean up and helical pathway transition work may be performed with a ball nose end mill, a ball grinder or a rotary saw style mill head, for example.

It will be appreciated that although end connection 705 on FIGS. 7 and 8 is illustrated as a cylinder, the scope of this disclosure is not limited in this regard. Other non-illustrated embodiments may provide end connections with upset geometries, in which machining or other work may be required before or after welding.

It will be further appreciated that although the embodiments illustrated on FIGS. 3 through 8 all illustrate (1) undercut stators and (2) cylindrical thread profiles on end connections, the scope of this disclosure is again not limited in either of these regards. Other non-illustrated embodiments, consistent with the specific disclosure associated with each of FIGS. 3 through 8, may provide non-undercut stator geometries and/or tapered thread profiles on end connections.

FIG. 1C depicts a similar method to FIG. 1B, except that in FIG. 1C, a previously-used stator with damaged end connection(s) is repaired to provide new end connection(s) of selected material. As in FIG. 1B, the end connections in FIG. 1C are joined to the tube via high strength weld connections (and again, advantageously, friction weld connections). Any of the embodiments depicted in FIGS. 3 through 8 may be used with the “repair” method illustrated on FIG. 1C, although as noted above with reference to FIG. 5, the embodiment illustrated on FIG. 5 is particularly suitable for repairs in accordance with FIG. 1C.

Referring now to FIG. 1C, method 120 begins by removing the damaged end connection from the stator tube, and, depending on the configuration and geometry of the existing stator tube, preparing the undercut or helical ends thereof and machining a flat end face thereon (box 121). The flat end face will form a contact surface for friction welding. It will be appreciated that the point at which the cut is made to remove the damaged end connection will determine the point at which the flat end face is formed in the stator tube. The cut point therefore dictates to a large extent (1) the overall final configuration and geometry of the repaired stator and (2) the overall methodology by which the repaired stator will be specifically made. Again, refer to FIGS. 3 through 8 and associated disclosure above for examples.

In box 122 on FIG. 1C, the new end connection cylinder(s) is/are prepared, advantageously made from a material selected to be of the same or higher yield strength than the stator tube material. A flat end face is machined on the end connection to form a contact surface for friction welding.

Boxes 123 and 124 on FIG. 1C refer to substantially the same processes and related disclosure as described above with respect to boxes 114 and 115 on FIG. 1B. In summary, the end connection is friction welded to the stator tube, and any necessary post-weld machining, grinding, milling or other treatment is applied so that the repaired stator conforms to the desired geometry, configuration and/or specification (for example, one of the embodiments illustrated on FIGS. 3 through 8).

Earlier in this disclosure, the advantage was described wherein embodiments manufactured according to FIG. 1B or 1C (examples of which are illustrated on FIGS. 3 through 8) allow for selection of different materials to be used in end connections and stator tubes. For example, end connections subjected to high bending stresses in service may optimally be made of higher yield strength material than the stator tube, in which a lower yield strength material may be used to facilitate formation of internal helical pathways. Table 1 below sets forth examples of end connection and stator tube materials that may be combined in friction-welded stators in accordance with the present disclosure.

TABLE 1

| | |
|---|---|
| End Connection material | Stator Tube material |
| (Yield Strength) | (Yield Strength) |

| | | | |
|---|---|---|---|
| 4140 - 110 | ksi | 4140 - 110 | ksi |
| 4142 - 110 | ksi | 4142 - 110 | ksi |
| 4145 - 110 | ksi | 4145 - 110 | ksi |
| 4130Mod - 130 | ksi | 4130Mod - 130 | ksi |
| 4340 - 125 - 140 | ksi | 4340 - 125-140 | ksi |
| 4145H - 120 | ksi | 1525 - 85 | ksi |
| 300M - 180 - 210 | ksi | 1040 - 80 | ksi |
| EN25 - 140 | ksi | 1026 - 75 | ksi |
| EN26 - 140 | ksi | 1018 - 65 | ksi |

Table 1 identifies exemplary steel types and grades for end connections and stator tubes, along with approximate yield strengths for each type and grade in units of kilopounds per square inch (ksi). It will be understood that materials identified in Table 1 are exemplary only, and that the scope of this disclosure is not limited to any particular combination of materials for end connections and stator tubes, whether called out as an example on Table 1 or not. The selection of materials will depend on a number of factors specific to the desired application and manufacturing method, including type of service, actual yield strength, toughness, workability, cost, availability and other factors. However, in currently preferred embodiments, end connections are made from steel with a similar or greater yield strength than the steel from which the stator tube is made. See Table 1 for examples. Preferably, end connections are made from a steel with a yield strength greater than 110 ksi, and more preferably greater than 120 ksi, and yet more preferably greater than 140 ksi. Likewise, in currently preferred embodiments, stator tubes are made from a steel with a yield strength greater than 65 ksi, and more preferably greater than 100 ksi, and yet more preferably greater than 120 ksi.

It will be appreciated that many of the exemplary material combinations suggested by Table 1 combine steels with comparable yield strengths that fall within the preferable criteria set out in the previous paragraph. However, additional consideration should be made when friction welding materials that have a wide difference in yield strength. Welded connections including particularly high yield strength steels may require additional preheat and/or post weld heat treatment, for example. Unless for a very specific application, in which the friction weld technique may have to be specially engineered, the end connection yield strength is preferably no more than 80 ksi greater than the stator tube yield strength, and more preferably no more than 40 ksi greater.

Although the inventive material in this disclosure has been described in detail along with some of its technical advantages, it will be understood that various changes, substitutions and alternations may be made to the detailed embodiments without departing from the broader spirit and scope of such inventive material as set forth in the following claims.

We claim:

1. A method for manufacturing one end of an undercut stator, the method comprising the steps of:
(a) providing a cylindrical tube as a single workpiece, the tube having a tube length and a cylindrical internal surface;
(b) designating a first end connection portion of the tube length at a first end of the tube, and designating a stator portion of the tube length wherein the stator portion immediately neighbors the first end connection portion;
(c) forming a plurality of helical pathways on the internal surface of the stator portion, each helical pathway having a common major helical diameter and a common minor helical diameter, wherein step (c) includes the substep of:
(c1) forming at least one of the helical pathways at least in part by broaching; and
(d) forming threads on the internal surface of the first end connection portion such that the threads provide an internal minimum thread diameter, wherein the major helical diameter is selected to be greater than the internal minimum thread diameter.

2. The method of claim 1, further comprising, after step (c), the step of deploying a layer of elastomer on the helical pathways.

3. The method of claim 1, in which substep (c 1) further includes forming at least one of the helical pathways (1) initially by electrochemical machining (ECM), and then (2) by broaching to finish.

4. The method of claim 1, in which the broaching in substep (c 1) is controlled at least in part by computerized numeric control (CNC).

5. A method for manufacturing one end of an undercut stator, the method comprising the steps of:
(a) providing an end tube with a cylindrical end internal surface and an end tube nominal diameter;
(b) providing a stator tube with a cylindrical stator internal surface;
(c) forming a plurality of helical pathways on the stator internal surface, each helical pathway having a common major helical diameter and a common minor helical diameter;
(d) designating a connecting end of the end tube and a connecting end of the stator tube, wherein the connecting ends of the end tube and the stator tube are to be conjoined;
(e) preparing the connecting ends of the end tube and the stator tube for friction welding together;
(f) friction welding the connecting ends of the end tube and the stator tube together; and
(g) forming threads on the end internal surface such that the threads provide an internal minimum thread diameter, wherein the major helical diameter is selected to be greater than the internal minimum thread diameter.

6. The method of claim 5, further comprising, after step (c), the step of deploying a layer of elastomer on the helical pathways.

7. The method of claim 5, in which step (e) includes machining cooperating flat faces onto the connecting ends of the end tube and the stator tube.

8. The method of claim 5, in which step (f) is accomplished at least in part by a process selected from the group consisting of:
(1) inertia welding; and
(2) direct drive welding.

9. The method of claim 5, in which step (c) is accomplished at least in part by a process selected from the group consisting of:
(1) electrochemical machining (ECM);
(2) roll forming; and
(3) broaching.

10. The method of claim 5, in which step (I) also includes machining a stress-relieving geometry into a transition between the stator internal surface and the end internal surface, the transition formed when the end tube is friction welded to the stator tube.

11. The method of claim 5, in which the end tube is made from a material having a higher yield strength than the material from which the stator tube is made.

12. The method of claim 5, in which a welded connection is formed between the connecting ends of the end tube and the stator tube when the end tube is friction welded to the stator tube in step (f), and in which the welded connection is located at a position selected from the group consisting of:
(1) minimum transverse cross-sectional area along the helical pathways formed in the stator tube;
(2) maximum transverse cross-sectional area along the helical pathways formed in the stator tube; and
(3) maximum transverse cross-sectional area of the end tube.

13. The method of claim 5, in which a welded connection is formed between the connecting ends of the end tube and the stator tube when the end tube is friction welded to the stator tube in step (f), and in which:
(1) the welded connection is located at a position along the helical pathways formed in the stator tube; and
(2) portions of the welded connection are removed after step (f) in order to provide a smooth transition between helical pathways and the end internal surface.

14. The method of claim 5, in which step (c) is accomplished at least in part by broaching, wherein said broaching includes forming a relief bore in the stator, the relief bore having a relief bore diameter, and in which further:
(1) a welded connection is formed between the connecting ends of the end tube and the stator tube when the end tube is friction welded to the stator tube in step (f); and
(2) the welded connection is located in the relief bore.

15. The method of claim 14, in which step (e) includes forming a transition in the end internal surface at the connecting end of the end tube, wherein the transition enlarges the end tube nominal internal diameter to a diameter substantially equal to the relief bore diameter.

16. A method for manufacturing one end of a stator, the method comprising the steps of:
(a) providing an end tube with a cylindrical end internal surface;
(b) providing a stator tube with a cylindrical stator internal surface;
(c) forming a plurality of helical pathways on the stator internal surface, each helical pathway having a common major helical diameter and a common minor helical diameter;
(d) designating a connecting end of the end tube and a connecting end of the stator tube, wherein the connecting ends of the end tube and the stator tube are to be conjoined;
(e) preparing the connecting ends of the end tube and the stator tube for friction welding together; and
(f) friction welding the connecting ends of the end tube and the stator tube together.

17. The method of claim 16, further comprising, after step (c), the step of deploying a layer of elastomer on the helical pathways.

18. The method of claim 16, in which the end tube is made from a material having a higher yield strength than the material from which the stator tube is made.

19. The method of claim 16, in which a welded connection is formed between the connecting ends of the end tube and the stator tube when the end tube is friction welded to the stator tube in step (f), and in which the welded connection is located at a position selected from the group consisting of:
(1) minimum transverse cross-sectional area along the helical pathways formed in the stator tube;
(2) maximum transverse cross-sectional area along the helical pathways formed in the stator tube; and
(3) maximum transverse cross-sectional area of the end tube.

20. The method of claim 16, in which a welded connection is formed between the connecting ends of the end tube and the stator tube when the end tube is friction welded to the stator tube in step (f), and in which:
(1) the welded connection is located at a position along the helical pathways formed in the stator tube; and
(2) portions of the welded connection are removed after step (f) in order to provide a smooth transition between helical pathways and the end internal surface.
